(19) United States
(12) Patent Application Publication
(10) Pub. No.: US 2005/0035556 A1
(43) Pub. Date: Feb. 17, 2005

(54) Annular seal

(76) Inventors: Brian Lang, Roanoke, VA (US); Richard York, South Bend, IN (US); Ralph Peterson, St. George, UT (US)

Correspondence Address: MAYER, BROWN, ROWE & MAW LLP, 190 SOUTH LASALLE ST, CHICAGO, IL, 60603-3441, US

(21) Appl. No.: 10/945,290

(22) Filed: Sep. 20, 2004

Related U.S. Application Data
(62) Division of application No. 10/287,230, filed on Nov. 4, 2002, now abandoned.

(51) Int. Cl. F16J 15/54

(52) U.S. Cl. 277/589

(57) ABSTRACT

An annular seal and method of producing the same wherein the annular seal comprises an annular outer portion comprising an outward facing surface and an inward facing surface; an annular rubber portion having an outer face and an inner face, wherein the outer face of the annular rubber portion is bonded to the inward facing surface of the annular outer portion; and wherein the inner face of the rubber portion comprises a plurality of bulged areas. Preferably, the outer portion comprises polytetrafluoroethylene or perfluoroalkoxy. The bulged areas may be disposed radially inwardly or axially.

### BACKGROUND OF THE INVENTION

1. Field of the Invention

The present invention relates to an annular seal to be used between moving parts. Particularly, the present invention is directed to an annular seal comprising an outer polytetrefluoroethylene portion bonded to an inner rubber portion to provide improved seal performance.

2. Description of Related Art

A variety of seals are known in the art for providing a seal between moving parts. The predominant application wherein such seals are used is in automatic transmissions. Automatic transmissions utilize a number of moving parts in conjunction with transmission fluid to control the operation of the transmission. In the typical automatic transmission embodiment, a shaft is provided which rotates relative to bore, or wherein the bore rotates relative to the shaft. It is desirable to provide a seal between the shaft and the bore which both minimizes friction (i.e., drag) between the shaft and bore, while at the same time creating a reliable seal to protect against transmission fluid leakage. Previous solutions have utilized a rigid material, such as polytetrafluoroethylene or plastic, which is installed onto the shaft. However, such materials would not easily permit stretching to fit over the shaft, resulting in either breakage of the seal or deformation of the seal to such a degree that the bore could not be installed over it. A solution has been to provide a cut in the seal to allow the seal to be installed over the shaft. However, the cut creates a leak path during the seal's normal operation, making such a solution less desirable. In addition, because of the rigidity of the material, such seals were ill-suited for an interference fit with the bore. Accordingly, leakage was an additional problem since the seal would not contact the opposing surfaces in the way a more elastic material might.

Use of more elastic materials, such as rubber, did not solve the problems. First, rubber was not well-suited to use with moving parts since the elasticity of the material greatly increased drag. Second, because of its elasticity, the rubber could extrude through gaps between the shaft and bore when the parts were moving, degrading the seal.

### SUMMARY OF THE INVENTION

The purpose and advantages of the present invention will be set forth in and apparent from the description that follows, as well as will be learned by practice of the invention. Additional advantages of the invention will be realized and attained by the methods and products particularly pointed out in the written description and claims hereof, as well as from the appended drawings.

To achieve these and other advantages and in accordance with the purpose of the invention, as embodied and broadly described, the invention includes an annular seal for use between moving parts, an embodiment of which comprises: an annular outer portion comprised of a low friction material comprising an outward facing surface and an inward facing surface; an annular rubber portion having an outer face and an inner face, wherein the outer face of the annular rubber portion is bonded to the inward facing surface of the outer portion; wherein the inner face of the rubber portion comprises a plurality of bulged areas; and wherein the outer portion has greater rigidity than the rubber portion. In the preferred embodiment, the outer portion comprises polytetrafluoroethylene. The outer portion may also comprise perfluoroalkoxy (“PFA”). In some embodiments, the bulges are defined by a radially inward facing valley in the rubber portion. Other embodiments comprise axial valleys in the rubber portion. In alternative embodiments of the invention, the outward facing surface of the outer portion comprises a beveled top edge and a beveled bottom edge. In some embodiments, the outer portion includes a filler, preferably although not necessarily a glass or carbon filler. In preferred embodiments, the outer portion material is a glass-filled or carbon-filled polytetrafluoroethylene.

The invention also includes a method for producing an annular seal in accordance with embodiments of the invention, comprising: etching an annular outer portion in an etching solution; coating an inward facing surface of the annular outer portion with an adhesive; placing the annular outer portion in a mold; adding rubber to the mold adjacent the inward facing surface of the annular outer portion; and curing the rubber to bond to the annular outer portion; wherein the mold is constructed to mold bulged areas in an inner face of the rubber. The outer portion comprises a low friction material having greater hardness and/or rigidity than the rubber portion of the seal—preferably, although not necessarily, polytetrafluoroethylene or perfluoroalkoxy. In some embodiments, the bulges are defined by a radially inward facing valley in the rubber portion. In further embodiments, the mold is further constructed to bevel an outward facing surface of the annular outer portion. In some embodiments, the mold is provided with chamfers, preferably 45° chamfers, to bevel the outer facing surface of the annular outer portion. In yet other embodiments, the etching solution is an alkaline solution. In additional embodiments, the outer portion includes a filler, preferably although not necessarily a glass or carbon filler. In preferred embodiments, the outer portion material is a glass-filled or carbon-filled polytetrafluoroethylene.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a plan cross sectional view of an embodiment of the annular seal of the present invention.

FIG. 2 is a cross sectional view along line A-A of the embodiment of the annular seal of the present invention depicted in FIG. 1.

FIG. 3 is a cross sectional view of another embodiment of the annular seal of the present invention.

FIG. 4 is a cross sectional view of an embodiment of a mold used to manufacture an annular seal in accordance with an embodiment of the present invention.

FIG. 5 is a top plan view of an embodiment of an annular seal of the present invention.

FIG. 6 is a cross sectional view along line B-B of the embodiment of the present invention depicted in FIG. 5.

FIGS. 7A-7D are a schematic representation of the tooling and methods for producing annular seals according to an embodiment of the present invention.

### DETAILED DESCRIPTION OF THE PREFERRED EMBODIMENT

Reference will now be made in detail to the present preferred embodiments of the invention, examples of which are illustrated in the accompanying drawings. The method and corresponding steps of the invention will be described in conjunction with the detailed description of the system.

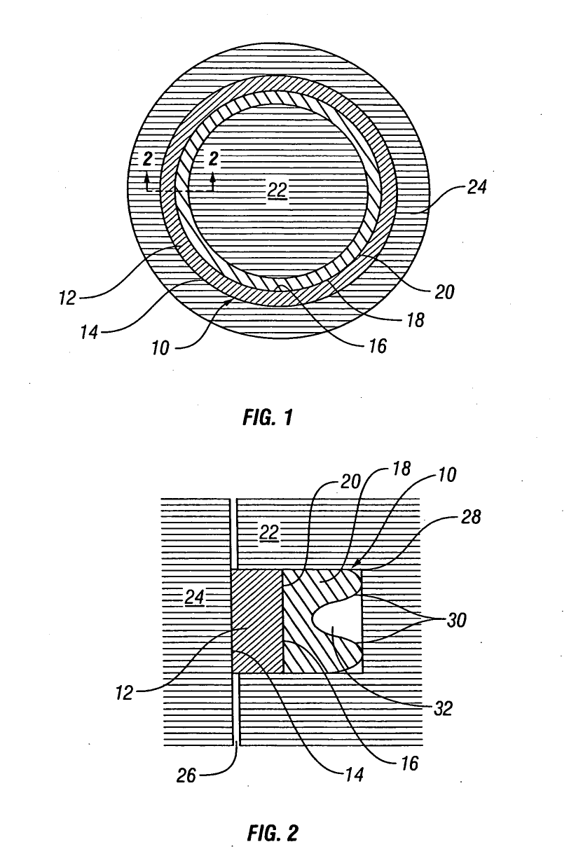

The methods and products presented herein may be used for a seal between two moving parts, including parts disposed for rotational or linear (e.g., telescoping) movement. The present invention is particularly suited for automatic transmission systems, although need not be so limited. For purpose of explanation and illustration, and not limitation, an exemplary embodiment of the system in accordance with the invention is shown in FIGS. 1 and 2 and is designated generally by reference character 10.

As shown in FIGS. 1 and 2, the annular seal 10 generally comprises an annular outer portion 12 having an outward facing surface 14 and inward facing surface 16. In the preferred embodiment described in detail herein, the annular outer portion 12 comprises polytetrafluoroethylene (“PTFE”). The annular seal 10 further comprises an annular rubber portion 18 having an outer face 20 bonded to the inward facing surface 16 of the PTFE portion 12. In practice, PTFE is the preferred, but by no means only material that may be used for the annular outer portion 12 in accordance with the present invention, so long as the annular outer portion 12 comprises a low friction material with greater hardness and/or rigidity than the inner rubber portion 18. For example, perfluoroalkoxy (“PFA”) may also be used for the annular outer portion 12, and nothing in the description herein should be read to limit the claims to an annular outer portion 12 comprising just PTFE.

According to the preferred embodiment, the annular seal 10 is placed over a shaft 22 disposed for rotation relative to a bore 24. The annular seal 10 is secured over the shaft 22 with an interference fit. Specifically, the elastic properties of the rubber portion 18 allow the seal 10 to be stretched over the shaft 22, but also pull the seal 10 back to its original size to permit a tight frictional fit about the shaft 22. The pressure exerted by the shaft 22 on the rubber portion 18, and hence on the PTFE portion 12, effectively seats the PTFE portion 12 against the sides of the bore 24.

Other features of the invention are depicted in FIG. 2. The annular seal 10 is seated in a groove 28 of the shaft 22 such that the rubber portion 18 is disposed radially inwardly of the shaft 22 and the PTFE portion is disposed radially outwardly against the wall of the bore 22. A gap 26 is provided between the shaft 22 and bore 24 to allow for free rotation between the parts. In the preferred embodiment, fluid, such as transmission fluid, is present in the gap 26. The annular seal 10 provides a seal to prevent leakage of such fluid while still allowing efficient movement between the shaft 22 and bore 24. It should be understood by reference to FIG. 2 that the present embodiments of the invention may be used for providing a seal between a shaft 22 and bore 24 regardless of their relative movement. For example, the seal 10 is suitable for circumstances wherein the shaft 22 telescopes in and out of the bore 24 because the PTFE portion 12 of the seal 10 that is disposed against the bore 24 will allow low friction movement in any relative direction.

According to one embodiment, the inward face of the rubber portion 18 of the annular seal 10 further comprises a plurality of bulged areas 30 with a valley 32 disposed between the bulged areas 30. Although the embodiment depicted in FIG. 2 depicts a seal 10 having a pair of bulged areas 30, any number of bulged areas may be utilized within the scope of the present invention. Because rubber is generally elastic but incompressible, the bulge areas 30 with associated valley 32 allows a tight interference fit between the rubber portion 18 and the shaft 22. This is so because, according to preferred embodiments, the bulged areas 30 deform as they exert an inward pressure on the shaft 22. The valley 32 provides an outlet for the deformation of the bulge areas 30, essentially allowing space into which the bulge areas 30 spread and providing an outlet for the pressure exerted on the rubber portion 12 by the shaft 22. In contrast, annular seals without bulge areas 30 and valleys 32, such as those having flat square or rectangular rubber portions, would need to be much thicker and would create much higher pressure on the PTFE portion as there would be no outlet for the pressure build up except to push outward on the PTFE portion of the seal. This increased pressure on the PTFE portion creates both excessive drag as the shaft and bore move relative to each other, and rapid build up of frictional heat, possibly leading to seal failure or other catastrophic events.

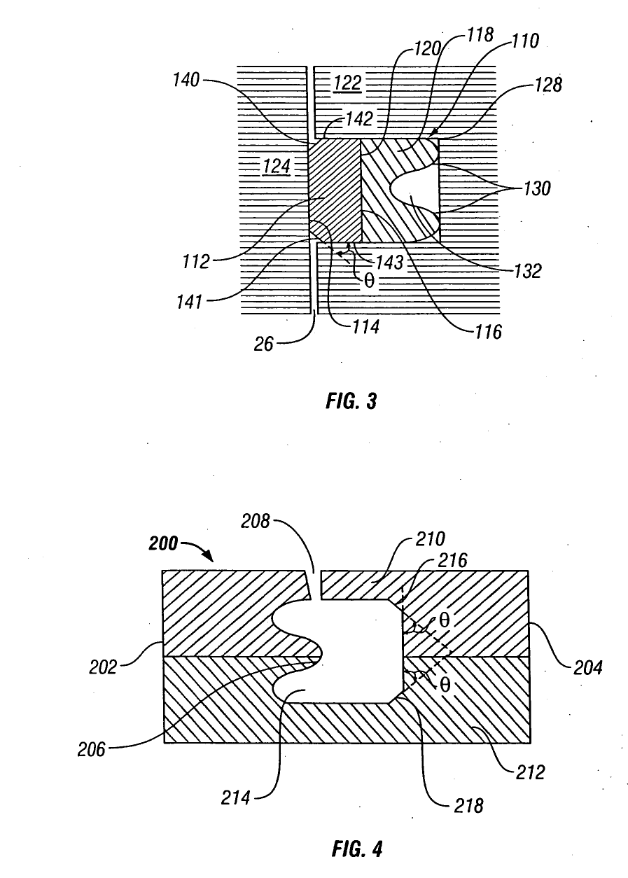

FIG. 3 depicts an alternative embodiment of an annular seal 110. This annular seal 110 is similar to annular seal 10 except for the presence of chamfers 140, 141 to bevel the top and bottom edges 142, 143 of the outer facing portion 114 of the PTFE portion 112. The presence of the chamfers 140, 141 allow additional space for the deformation of the PTFE portion 112 due to outward pressure, minimizing the amount of extrusion into the gap 126. According to a preferred embodiment, the chamfers 140, 141 are cut at an angle θ equal to 45°. However, alternative angles may be substituted. In practice, the angle θ may not equal to 45°, even if the mold is set at that angle, because the springiness of the material comprising the annular outer portion may cause the angle to change slightly upon removal from the mold.

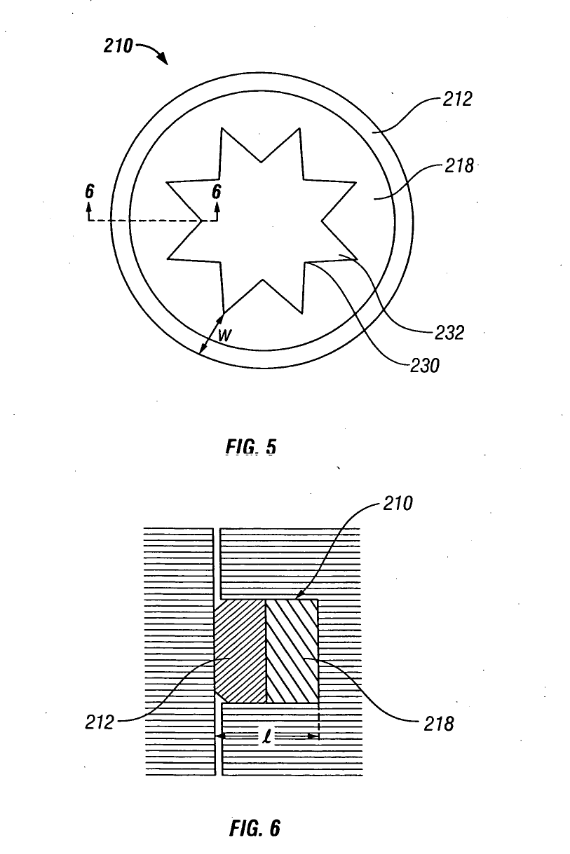

FIGS. 5 and 6 depict yet another embodiment of an annular seal 210. This annular seal 210 comprises bulge areas 230 oriented perpendicularly to the annular seal of the previously described embodiments. As can be seen from the plan view in FIG. 4, the bulge areas 230 of the present annular seal 210 are defined by a plurality of axial valleys 232 in the inner face of the rubber portion 218. In this embodiment, the bulge areas 230 of the rubber portion 218 deform into the valleys 232 by spreading substantially circumferentially, rather than axially as in the embodiments described above. It has been discovered that according to the preferred embodiments, the width w of the annular seal 210 at the thinnest portion, the base of the valley 232, is 60% of the length l of the groove 28 wherein the seal 210 is seated (see FIG. 6). However, other sizes and ratios may be used depending upon, for example, the hardness and elasticity of the rubber comprising the rubber portion 218.

In practice, the annular seals of the present invention are best manufactured in the manners herein disclosed. According to one of the preferred methods, an annular PTFE portion is provided. In the preferred application, such as automatic transmission systems, the annular PTFE portion has a thickness of about 0.75 mm, and the seal has a height of about 2-3 mm and overall diameter of about 48-60 mm. However, any size seal can be created in accordance with the present invention. In a preferred embodiment, the PTFE portion is cut from a tubular PTFE sleeve to yield a plurality of annular PTFE portions to mass produce the annular seals of the present invention. However, the present invention is susceptible to any method of providing an annular PTFE portion, as well as PTFE portions of any dimension suitable to the application to which the seal is to be put. In preferred embodiments, although not necessarily, the PTFE is a glass-filled PTFE or carbon-filled PTFE. It is believed that such PTFE materials promote better bonding with the rubber portion and promote better longevity and/or durability of the PTFE portion.

According to the next step, the PTFE portion is etched with an etching solution, preferably and alkaline etching solution, to promote bonding between the PTFE portion and the later inserted rubber portion. In the preferred embodiment, the etching solution is an alkaline solution, such as without limitation, sodium napthalate. However, other etching solutions, including non-alkaline solutions, may be used. After etching the PTFE portion, the inward facing surface is coated with an adhesive.

The coated PTFE portion is then placed in a mold, a cross section of the preferred embodiment of which is depicted in FIG. 4. The mold 200 is a circular, steel mold comprising a top portion 210 and lower portion 212. The mold 200 further comprises a generally annular gap 214 wherein the annular seal is produced. The top portion 210 of the mold 200 comprises a chamfer 216 to create the top chamfer in the annular seal, and the lower portion 212 of the mold 200 comprises a second chamfer 218 to create the lower chamfer in the annular seal. The chamfers 216, 218 of the preferred embodiment are arranged at a 45° angle θ to create a 45° bevel in the annular seal. However, molds in accordance with the present invention may be provided without chamfers or with chamfers having other angles. The mold also comprises a rib 206 to create the valley and bulge areas of the rubber portion.

The PTFE portion is placed in the mold 200 towards the outer circumference 204 of the mold 200. The top portion 210 is placed over the bottom portion 212, and rubber is inserted into the gap 214 through insertion orifice 208. In preferred molds, there are four insertion orifices 208 spaced evenly about the circumference of the top portion 210 of the mold 200, for example, at 12 o'clock, 3 o'clock, 6 o'clock and 9 o'clock when viewed from above. However, the number of orifices 208 may be less or more than four, depending upon the size of the annular seal and other production factors.

Before the rubber is inserted into the gap 214 through insertion orifices 208, the mold 200 is heated. In the preferred embodiment, the pre-heating is sufficient to cure the rubber and complete the production of the seal. In preferred embodiments, and depending upon the properties of the rubber and PTFE materials, the mold is heated to 350°-400° F., although other ranges may be used in accordance with the invention. In preferred embodiments, the seal is heated from 30 seconds to several minutes, although other time periods may be used in accordance with the invention. In addition to the above described transfer molding, the present seal can be manufactured according to the above method through compression or injection molding.

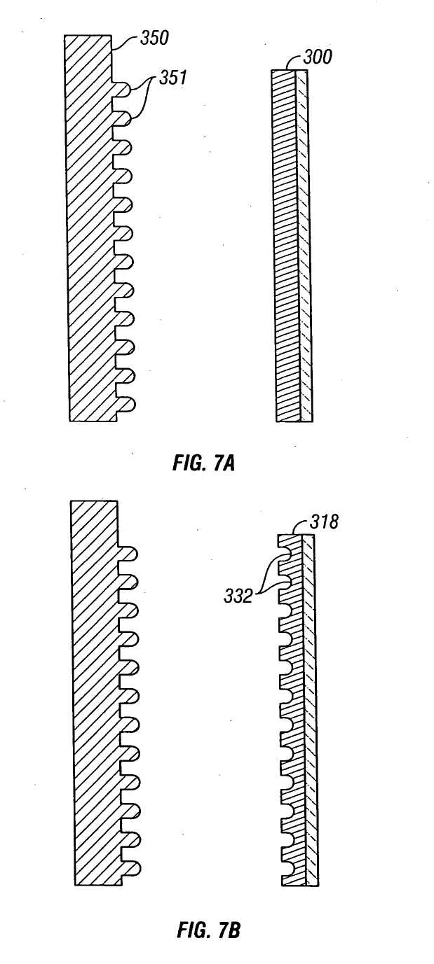

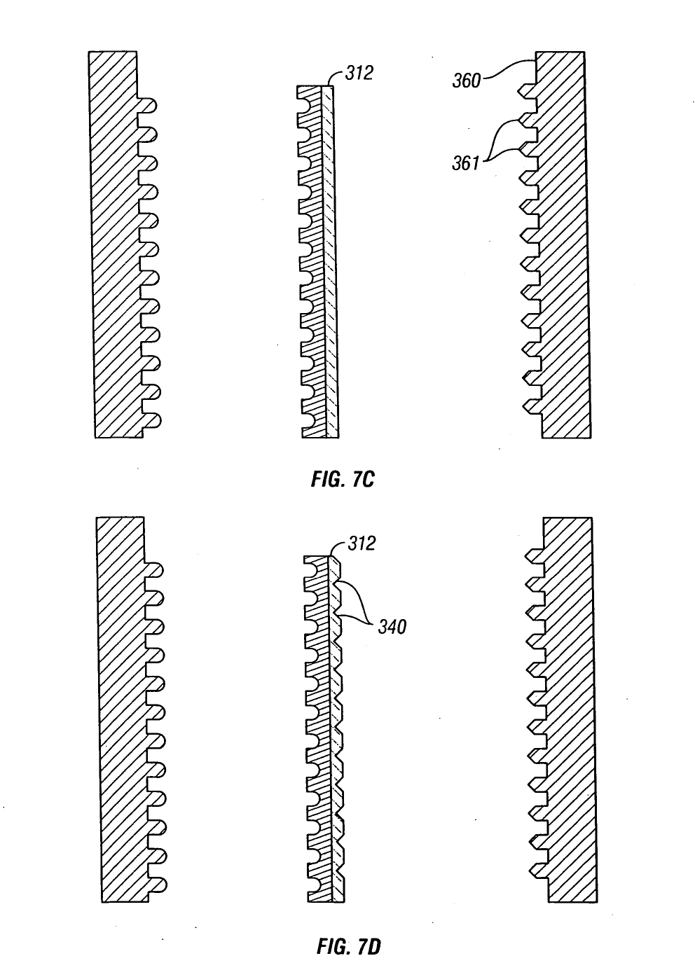

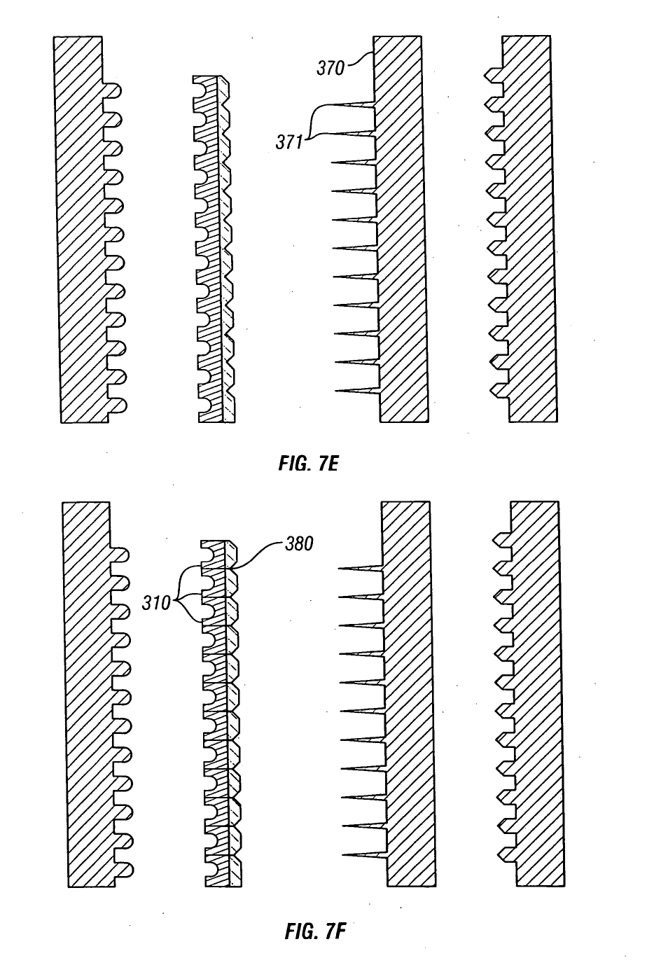

Another method according to the present invention is depicted schematically in FIGS. 7A-F. FIGS. 7A-F depict cross sections of the various stages of production for the annular seals. The first step is to provide a sleeve of low friction material 312, preferably PTFE or PFA, molded with adhesive substantially as set forth above, to an inner rubber sleeve 318. The entire sleeve 300 is placed on a lathe comprising an inner cutting portion 350, an outer cutting portion 360 and a slicing mechanism 370. The inner cutting portion 350 comprises protruding cutters 306 to engage the inner rubber portion 318 of the rotating sleeve 300 to cut valleys 332 along the length of the sleeve 300. The valleys 332 will comprise the valleys between the bulge areas of the finished seals. An outer cutting portion 360 having a set of angled cutters 361 is also provided to engage the outer PTFE portion 312 to produce the chamfers 340 along the length of the sleeve 300. Finally, a slicing mechanism 370 having a plurality of slicing blades 371 is provided. The slicing blades 371 engage the sleeve 300 to cut the sleeve 300 into a plurality of identical annular seals 310.

It will be apparent to those skilled in the art that various modifications and variations can be made in the method and product of the present invention without departing from the spirit or scope of the invention. Thus, it is intended that the present invention include modifications and variations that are within the scope of the appended claims and their equivalents.

1. An annular seal for use between moving parts comprising:
an annular outer portion comprising an outward facing surface and an inward facing surface;
an annular rubber portion having an outer face and an inner face, wherein the outer face of the annular rubber portion is bonded to the inward facing surface of the annular outer portion; and
wherein the inner face of the rubber portion comprises a plurality of bulged areas.

2. The annular seal of claim 1 wherein the annular outer portion comprises a low friction material having a hardness and/or rigidity greater than the annular rubber portion.

3. The annular seal of claim 2 wherein the annular outer portion comprises polytetrafluoroethylene.

4. The annular seal of claim 2 wherein the annular outer portion comprises perfluoroalkoxy.

5. The annular seal of claim 1 wherein the outward facing surface of the annular outer portion comprises a beveled top edge and a beveled bottom edge.

6. The annular seal of claim 2 wherein the annular outer portion includes a filler.

7. The annular seal of claim 6 wherein the annular outer portion comprises glass-filled polytetrafluoroethylene.

8. The annular seal of claim 6 wherein the annular outer portion comprises carbon-filled polytetrafluoroethylene.

9. The annular seal of claim 1 further comprising an adhesive layer between the annular outer portion and the rubber portion.

10. The annular seal of claim 1 wherein the bulged areas comprise radially inwardly bulged areas.

11. The annular seal of claim 1 wherein the bulged areas comprise a plurality of axially bulged areas.

12. The annular seal of claim 5 further comprising approximately 45° chamfers.

13. A method for producing an annular seal for use between moving parts comprising:
etching an annular outer portion in an etching solution;
coating an inward facing surface of the annular outer portion with an adhesive;
placing the annular outer portion in a mold;
adding rubber to the mold adjacent the inward facing surface of the annular outer portion; and
curing the rubber to bond to the annular outer portion;
wherein the mold is constructed to mold annular bulged areas in an inner face of the rubber.

14. The method of claim 13 wherein the annular outer portion comprises a low friction material having a hardness and/or rigidity greater than the annular rubber portion.

15. The method of claim 14 wherein the annular outer portion comprises polytetrafluoroethylene.

16. The method of claim 14 wherein the annular outer portion comprises perfluoroalkoxy.

17. The method of claim 13 wherein the mold is further constructed to bevel an outward facing surface of the annular outer portion.

18. The method of claim 13 wherein the etching solution is an alkaline solution.

19. The method of claim 18 wherein the alkaline solution is sodium napthalate.

20. The method of claim 13 wherein the annular outer portion includes a filler.

21. The method of claim 20 wherein the annular outer portion comprises glass-filled polytetrafluoroethylene.

22. The method of claim 20 wherein the annular outer portion comprises carbon-filled polytetrafluoroethylene.

23. The method of claim 13 wherein the mold is provided with 45° chamfers to bevel the outer facing surface of the annular outer portion.

24. The method of claim 13 wherein the bulged areas comprise radially inwardly bulged areas.

25. The method of claim 13 wherein the bulged areas comprise a plurality of axially bulged areas.

26. A method for producing an annular seal for use between moving parts comprising:
molding an annular rubber sleeve to an inner face of an annular outer sleeve to produce a molded sleeve having an inner rubber portion and an outer annular portion;
cutting a plurality of equally spaced outwardly radially disposed valleys along the length of the inner rubber portion;
slicing the molded sleeve at midpoints between the valleys to produce a plurality of annular seals.

27. The method of claim 26 further comprising cutting chamfers in the outer annular portion.

28. The method of claim 26 wherein the annular outer portion comprises a low friction material having a hardness and/or rigidity greater than the annular rubber portion.

29. The method of claim 28 wherein the annular outer portion comprises polytetrafluoroethylene.

30. The method of claim 28 wherein the annular outer portion comprises perfluoroalkoxy.

31. The method of claim 26 wherein the annular outer portion includes a filler.

32. The method of claim 31 wherein the annular outer portion comprises glass-filled polytetrafluoroethylene.

33. The method of claim 31 wherein the annular outer portion comprises carbon-filled polytetrafluoroethylene.

34. The method of claim 26 wherein the chamfers are 45° chamfers.
